(19) United States
(12) Patent Application Publication
(10) Pub. No.: US 2004/0233962 A1
(43) Pub. Date: Nov. 25, 2004

(54) Surface emitting laser

(76) Inventor: Douglas Charles John Reid, Warwickshire (GB)

Correspondence Address: LAHIVE & COCKFIELD, LLP., 28 STATE STREET, BOSTON, MA, 02109, US

(21) Appl. No.: 10/487,689

(22) PCT Filed: Jul. 30, 2002
(86) PCT No.: PCT/GB02/03499

(30) Foreign Application Priority Data
Aug. 24, 2001 (GB) 0120621.8

(51) Int. Cl. H01S 3/091

(52) U.S. Cl. 372/75

(57) ABSTRACT

The laser comprises an active layer (4) with edges cleaved and/or dry etched so that the electromagnetic radiation undergoes total internal reflection. The layer is bounded on one face by a laser substrate (7) and on the other by a Bragg grating having lattices extending in second (11) and first (12) orthogonal directions, each of pitch related to that of the other and to the desired wavelength of the laser. Adjacent the substrate (7) is a heat sink (40), which acts as return path for electrical energy. Adjacent the grating (11, 12) is an electrode layer (24) having a window (26) through which the output laser energy (42) is radiated.

The present invention relates to a surfce-emitthng laser. More particularly, but not exclusively, it relates to a high power laser (i.e. CW optical powers above 50 mW). High power lasers also have applications in industrial processes, printing, medical procedures, precision cutting tools, and military applications, amongst others. The present surface emission laser can find application in any of the described laser uses, and may also be operated at lower powers. Whilst the present invention describes a laser for a telecommunication application wavelength this is not meant in any way to be a limitation to the operating frequency as the design principles apply to any solid state laser design that relies upon Bragg reflectors within a confined waveguide.

Optical amplifiers are essential to wavelength division multiplexing (WDM) communicanons systems using, for exampie, the 1.55 μm telecommunications wavelength. Optical amplifiers provide the means of amplifying optical signals, for onward transmission, without recourse to demodulating the superimposed information and remodulating said information upon a new high power optical carrier source (so called regenerative repeaters).

There are a number of differing means providing optical amplification, the most common being:

1. Semiconductor Optical Amplifiers (SOA).

2. Erbium Doped Fibre Amnplifiers (EDFA's).

3. Raman Fibre Amplifiers (RFA's).

Of these, SOA (Semiconductor Optical Amplifiers) are particularly useful for providing optical amplification at the WDM system terminal equipment, and within source electro-optical equipment EDFA's and RFA's are used as “pumped optical amplifiers” satisfying the need to boost signals on long haul, high capacity circuits. EDFA's rely upon special erbium doped fibre as a gain medium, which is pumped with an out of band high power laser. RFA's use standard transmission mode fibre as a gain mtedium, but similarly rely upon a high power, out of band, laser pump source. Both EDFA's and RFA's typically use a pump laser source at 980nm or 1480nm wavelength.

The means by which EDFA's and RFA's provide their optical amplification is well known and it is not necessary to detail the physics of EDFA's and RFA's to gain an understanding of the invention.

Optical telecoammnications systems typically rely upon source powers in the range of 10-40 mW for a given optical wavelength. Such powers are available directly from many types of solid state lasers and their associated modulators. Optical amplifers are required to provide 15-20 dB of gain across the wavelengths of interest. On a WDM system this may require a total output power from the optical amplifier of many hundreds of milli-watts of optical energy. Thus the optical power required to pump either an EDFA or RFA is in the hundreds of milli-watts of optical continuous wave (CW) power. A typical 980 nm CW laser pump source will produce 300 mW of optical power. In the case of RFA's there is a threshold pump power density necessary for the Raman amplification to take place.

The above is by way of explanation that in optical telecommunications there is a need for high power lasers.

Distributed Feedback Bragg (DFD) lasers are well known, and the physics of DFB lasers can be found in textbooks on optical fibre communication such as in chapter 6.62 of “Optical Fibre Communications”—Second Edition, Prentice Hall International, ISBN 0-13-635426-2.

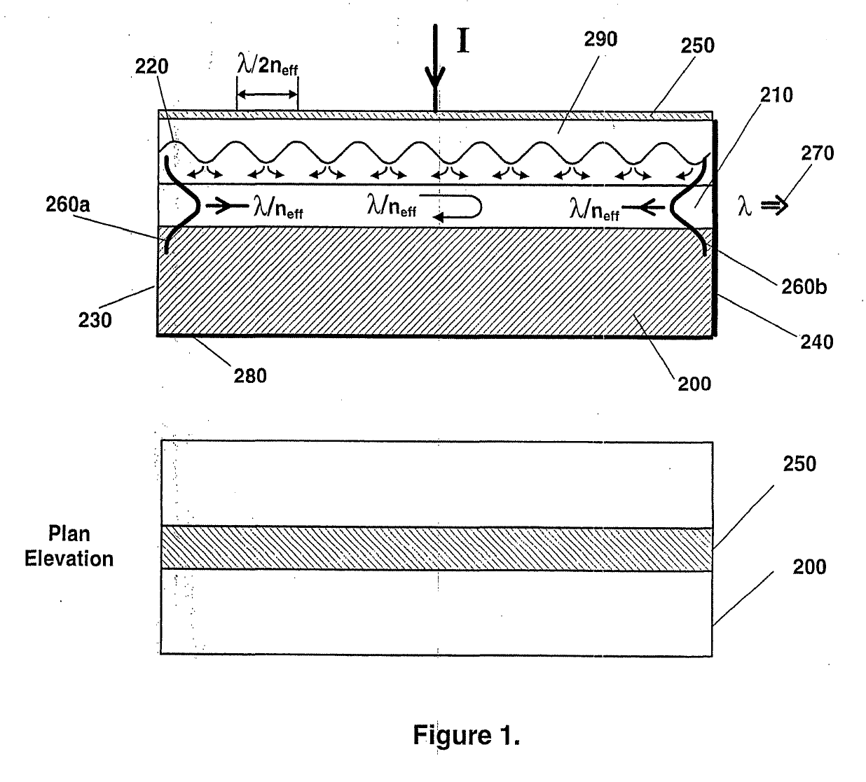

By way of example, FIG. 1 shows schematically a DFB laser in which a suitable substrate 200 such as InP has an active layer of InGaAsP 210 grown thereon. Layer 210 acts as a waveguide bounded by regions of lower refractive index such that it will support single-mode optical wavelength electromagnetic radiation propagation. The detail of the active layers will not be given, as they are superfluous to an understanding of the invention and would be known to those of ordinary skill in the art The invention will be described with reference to the use of Group III-V semiconductor materials, which are of particular commercial importance, but other semiconductor materials might also be used.

A Bragg grating 220 is fabricated above the active waveguide layer using standard semiconductor processing techniques. Either an electron beam or holographic process may be used to write the Bragg grating. The Bragg grating is infilled with a layer of P doped InP, having a lower refractive index, and a metal electrode 250 of a suitable material, such as gold, is applied. The materials and layering are given by way of example only.

With reference to FIG. 1, the Bragg grating 220 has a pitch that is half the wavelength, i.e. λ/2n_{eff}, of the electromagnetic radiation in the waveguide. The laser operates by electrically pumping the active layer with current I via the metal electrode 250, with the current return being completed via the substrate 200 which has a suitable metal contact 280 applied to it. The materials in the active region are selected for device growth and supporting photonic emission at the wavelengths of interest. Above a pump current threshold the active region 210 generates light. One end 230 of the laser device is a cleaved end that acts as a perfect reflector. The other end 240 of the device is cleaved and coated with an anti-reflection coating so that it allows a proportion of the generated light 270 to be emitted. The emitted level might, for example, be 10% of the light. The lasing action is based upon the emitted photons in the active layer being confined within a single mode waveguide that is bound at each end by mirrors, one of which is imperfect. As single mode waves 260a and 260b build up within the active layer waveguide, so the evanescent wave interacts with the Bragg grating which produces a reflection of the electromagnetic radiation at twice the grating pitch wavelength i.e. λ/n_{eff} where n_{eff} is the effective refractive index of the active layer 210. The Bragg grating reflection stimulates further photonic emission in the active layer, at a wavelength λ/n_{eff}. The reflections at the ends of the device result in a lasing action being established at a wavelength λ/n_{eff}, with the pump energy being preferentially converted into electromagnetic radiation. The coherent light output 270 can then to be coupled into further optical devices.

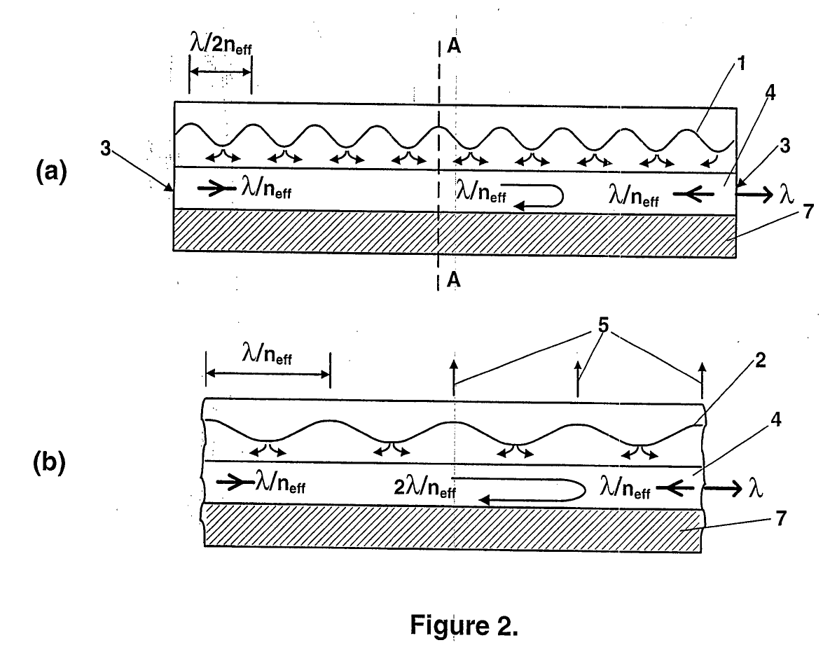

FIG. 2(a) schematically shows a DFB laser of the type shown in FIG. 1, but in less detail, in particular missing out the electrical connections. The waveguide and active layer 4 is fabricated above the substrate 7. Atop the active layer is the Bragg grating 1, of pitch λ/2n_{eff}. The ends of the laser device are shown having reflecting ends 3. The emitted wavelength is λ. Single mode propagation is supported within the waveguide 4.

FIG. 2(b) schematically shows a similar laser as FIG. 2(a) but the Bragg grating 2 has a pitch of λ/2n_{eff}. Electro-magnetic radiation of wavelength λ/n_{eff}will see the Bragg grating 2 as a second order grating, and thus will be back diffracted, however some of the energy 5 will out-couple from the grating layer 2. The out-coupling occurs because the electromagnetic radiation of wavelength λ/n_{eff} is in phase at corresponding points along the sinusoidal Bragg grating. Where the pitch of the grating is λ/n_{eff}, the outcoupled light will be directed substantially normally to the plane of the grating. However, while outcoupling will occur to some degree as long as the pitch of the grating is greater than λ/2n_{eff}, the light will be emitted at an angle to the plane of the grating.

In the case of a grating with a pitch of λ/2n_{eff} corresponding points are π/2 out of phase and so destructively interfere and no out-coupling occurs.

It is thus an object of the invention to obtain electromagnetic radiation in a direction perpendicular to the active layer, and to that end a Bragg grating structure is required that incorporates first and second order laser grating properties.

According to the present invention there is provided a high-powered surface emitting laser device comprising an active layer bounded on one face by a Bragg grating layer having a first lattice of pitch equal to λ/2n_{eff} and a second lattice orthogonal thereto and having a pitch greater than λ/2n_{eff}, where λ is the wavelength of the emitted electromagnetic radiation, and n_{eff} is the effective refractive index seen by the propagating wavefront in the active layer

Preferably the pitch of the second lattice is a multiple of that of the first lattice.

Advantageously the pitch of the second lattice is twice that of the first lattice, namely λ/n_{eff}.

The Bragg grating layer may be formed by a holographic process in which a photoresist layer is exposed sequentially to a first coherent electromagnetic beam and then to a second coherent electromagnetic beam at a predetermined angular offset from the first.

In an alternative arrangement, the Bragg grating layer may be formed by direct electron beam writing.

The second grating lattice may be stronger than the first grating lattice, particularly but not necessarily when electron beam writing is employed.

Alternatively, the second grating lattice may be equal in strength to the first grating lattice.

The Bragg grating layer may be configured as an irrational rectangle.

For example a rectangle having dimensions in the ratio of 1:(√5+1)/2 (i.e. 1.618034).

The Bragg grating layer may be configured as a rectangle having one dimension a rational multiple of the other.

The surface emitting laser may further comprise an electrode layer adjacent the Bragg grating layer, said electrode layer having window means to permit exit of the laser light.

The window means may have a quadrilateral shape, preferably square.

In this case, a side of the window may be aligned parallel with one of the Bragg gratings, or at a predetermined angle to one of the Bragg gratings.

Alternatively, the window means may be circular, elliptical or oval.

In another embodiment, the window means may comprise a plurality of small apertures distributed over a window zone of the electrode layer.

In a further embodiment, an electrode layer including window means is spaced from said Bragg grating layer by a transparent laser substrate layer.

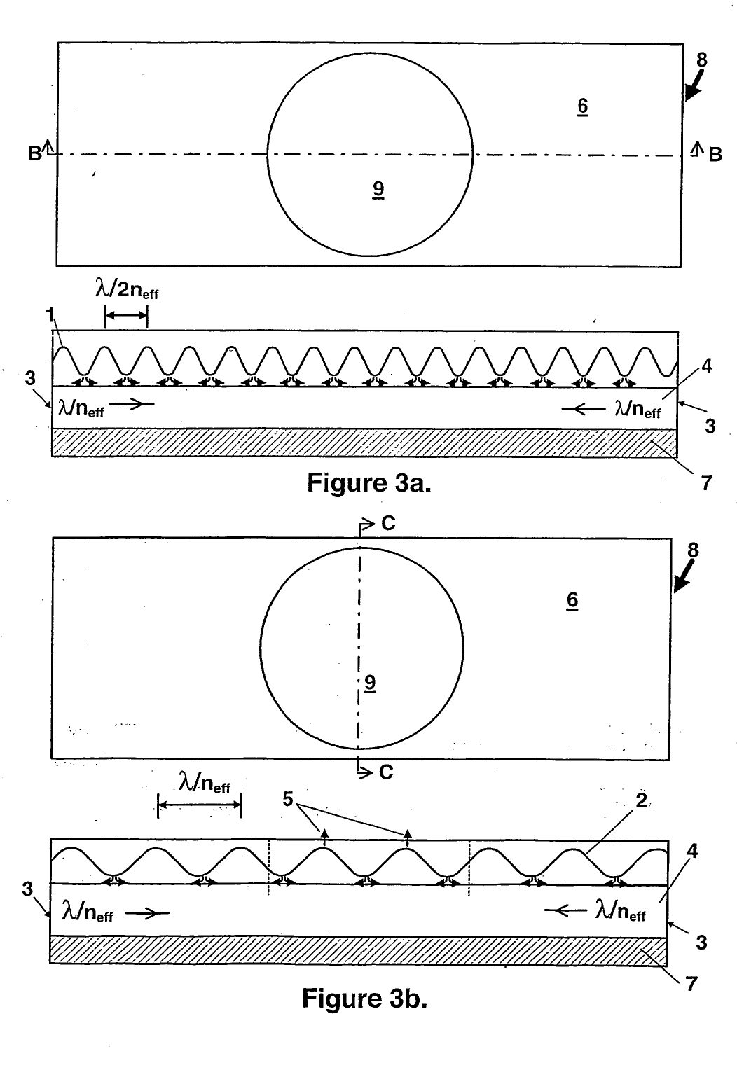

Embodiments of the invention will now be more particularly described, by way of example and with reference to FIGS. 3 to 20 of the accompanying drawings, in which:

FIG. 1 is a schematic side and plan view of a known DFB (distributed feedback Bragg) laser;

FIGS. 2a and 2b show schematically two DFB lasers of known type, each having a Bragg grating of different pitch;

FIGS. 3a and 3b show schematically in plan and cross sectional views a DFB laser embodying the invention;

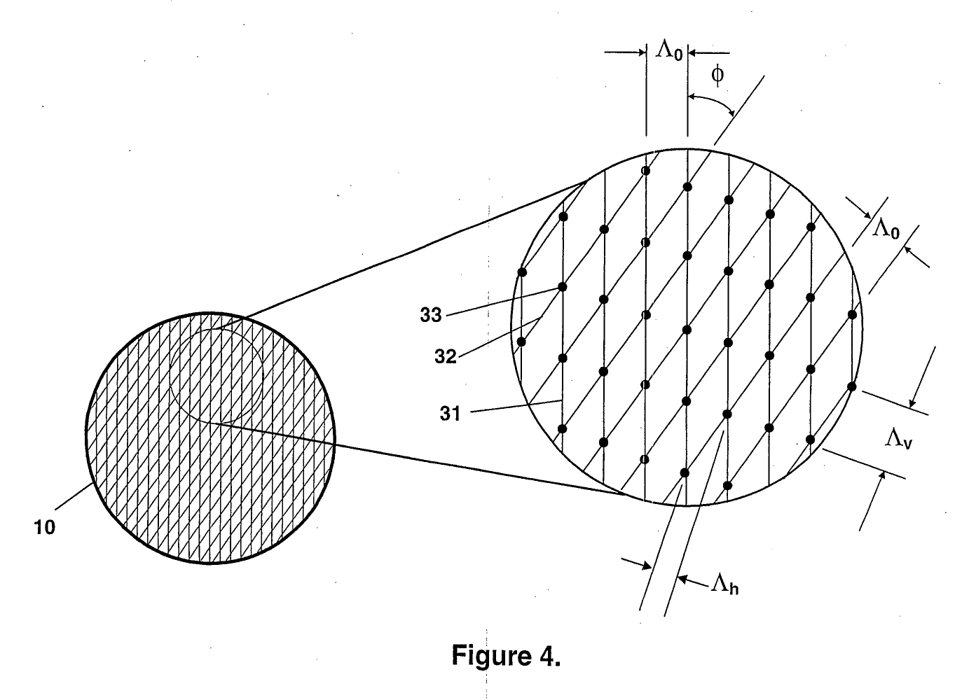

FIG. 4 is a schematic representation, to an enlarged scale, of a lattice formed from two Bragg gratings;

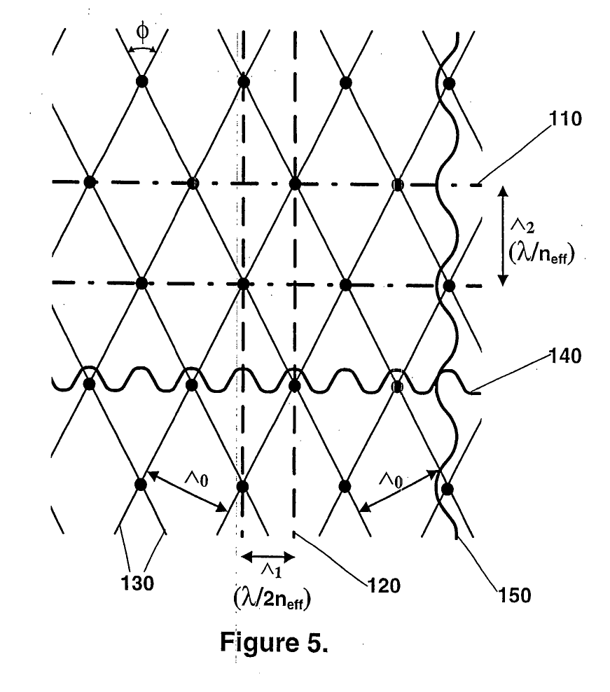

FIG. 5 shows schematically the formation of two orthogonal first order gratings;

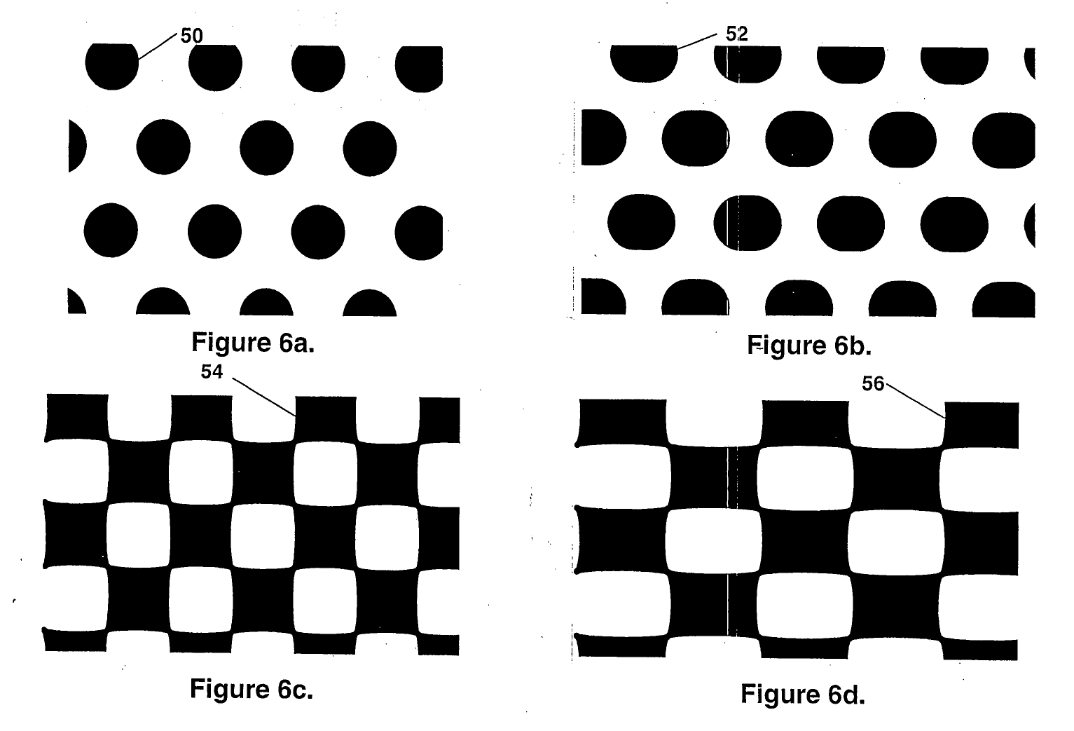

FIGS. 6a, 6b, 6c and 6d are schematic representations of a variety of etched planar patterned gratings;

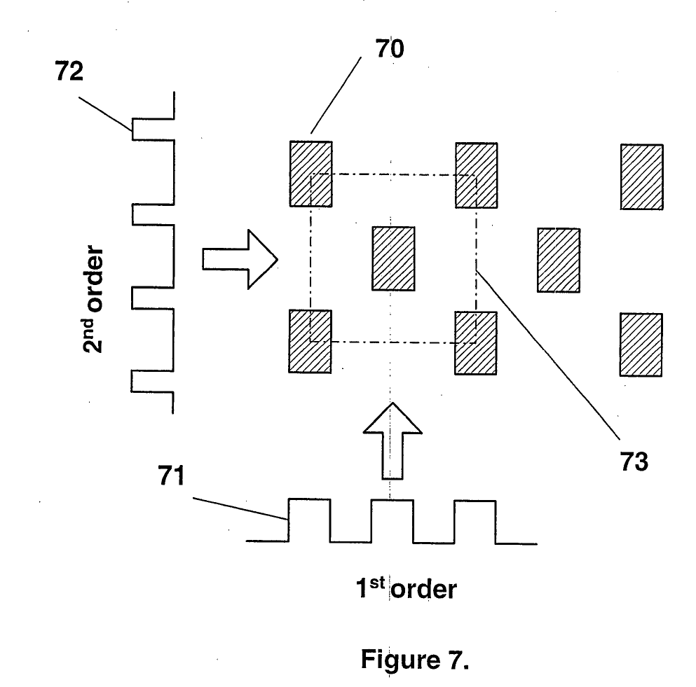

FIG. 7 shows schematically a Bragg grating where one grating is directionally enhanced;

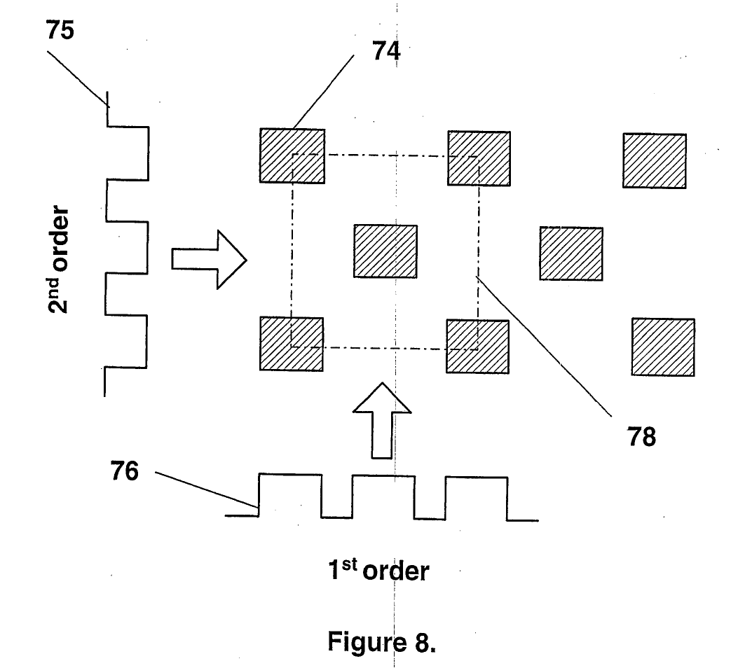

FIG. 8 shows schematically a Bragg grating where the nodes have the same area as those of FIG. 7 but a different profile;

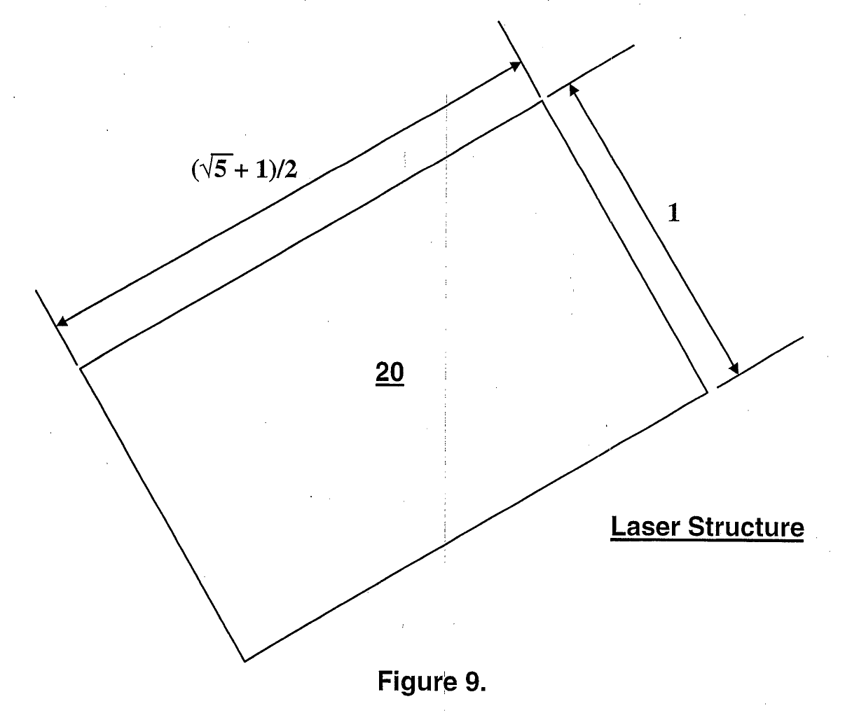

FIG. 9 is an irrational rectangular shape useful in the present laser;

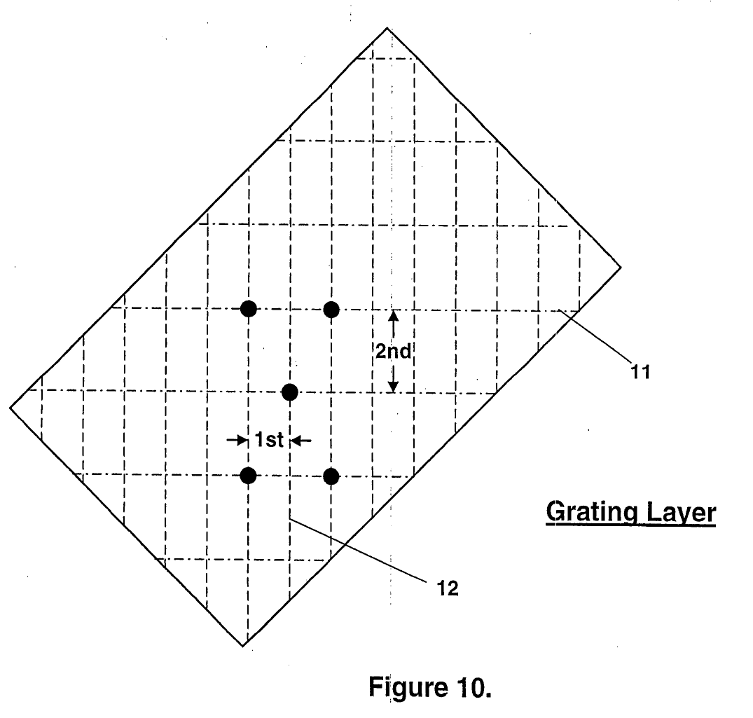

FIG. 10 illustrates the relationship between the Bragg grating and the irrational shape of FIG. 9;

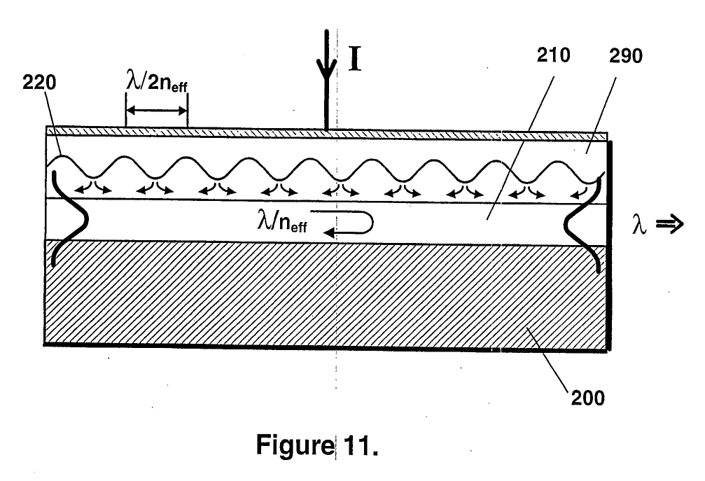

FIG. 11 is a schematic cross section of a laser embodying the invention;

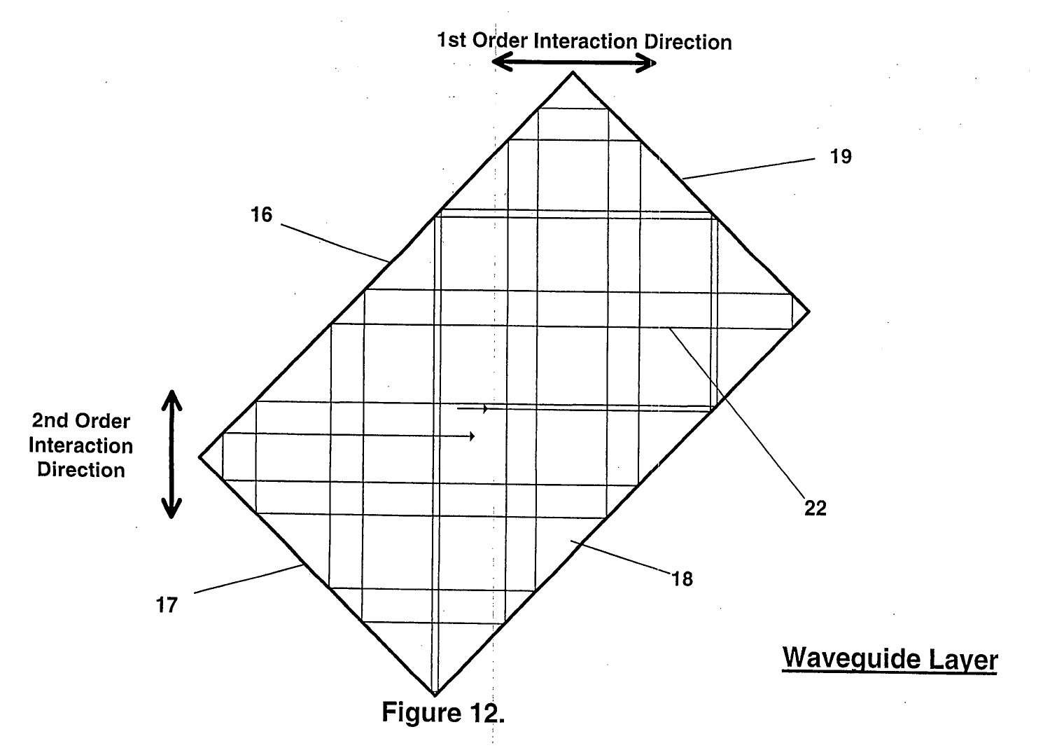

FIG. 12 is a cross sectional view from above of the waveguide layer showing a pathway for light;

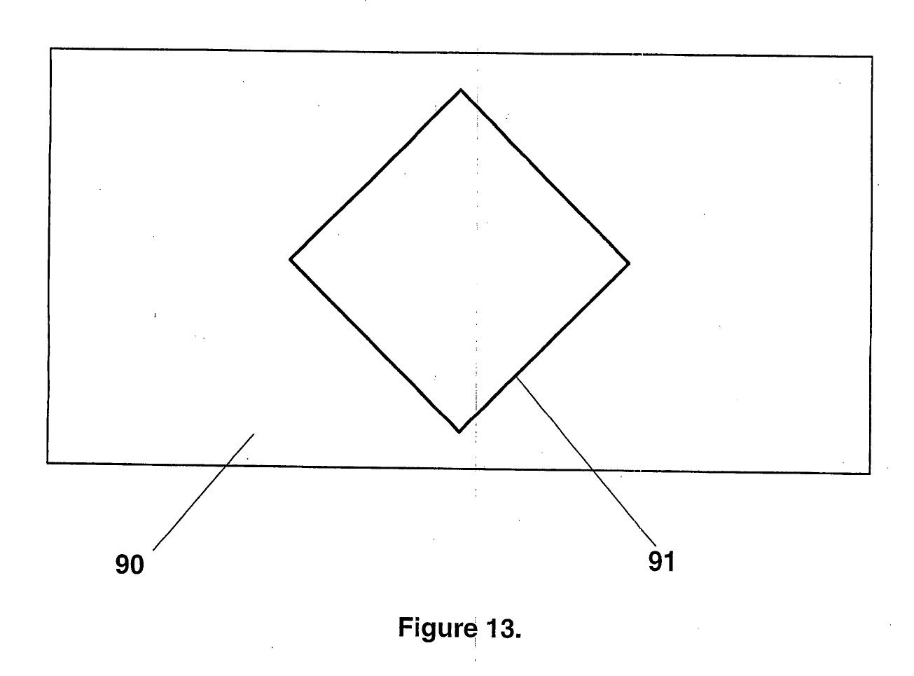

FIG. 13 is a plan view showing the electrode layer;

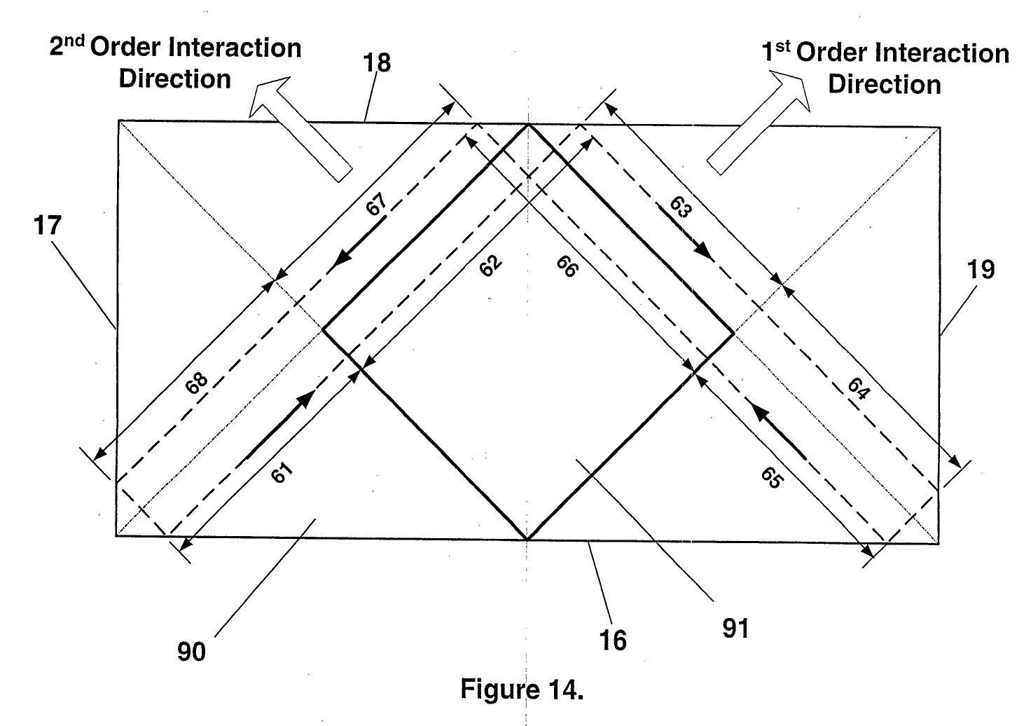

FIG. 14 shows another embodiment with a rational shape;

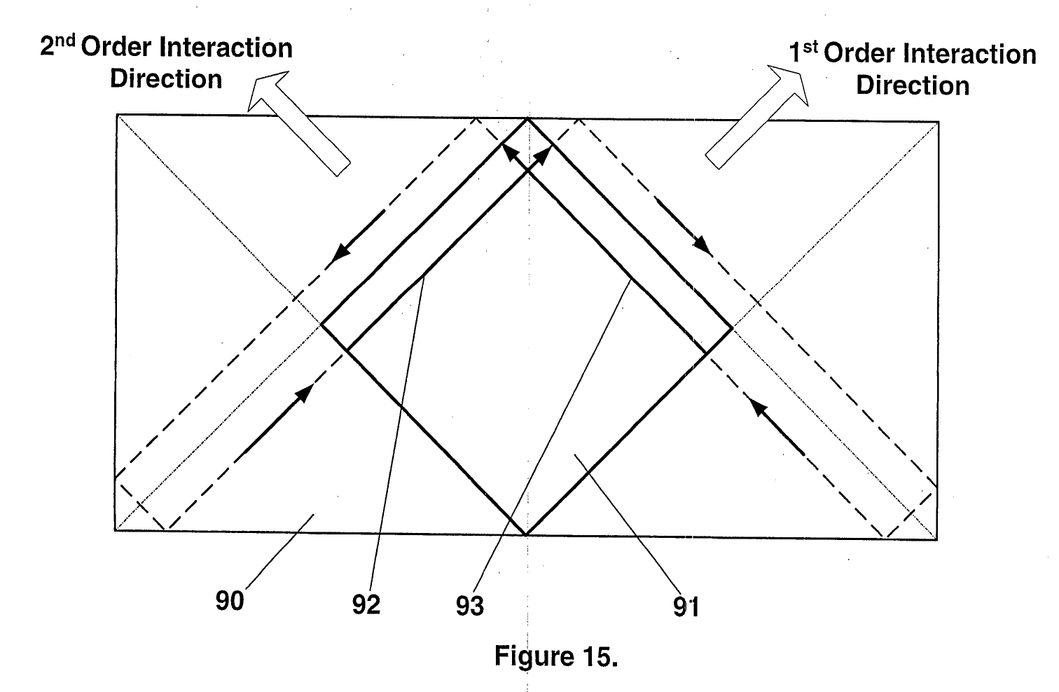

FIG. 15 is a cross sectional view showing a pathway through the embodiment of FIG. 14;

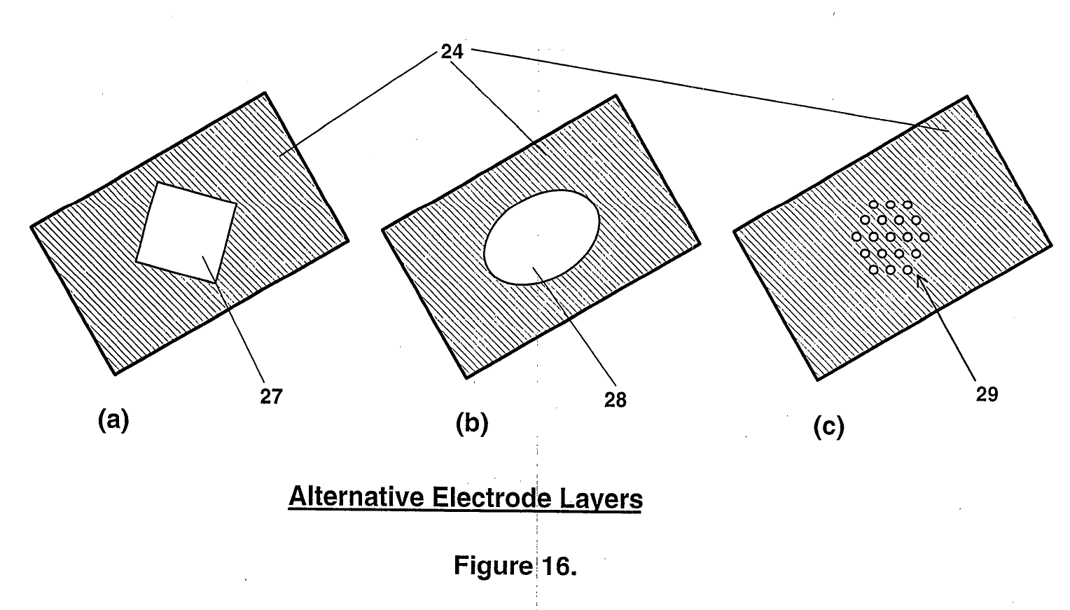

FIGS. 16a, 16b and 16c show alternative electrode layers with differently shaped windows;

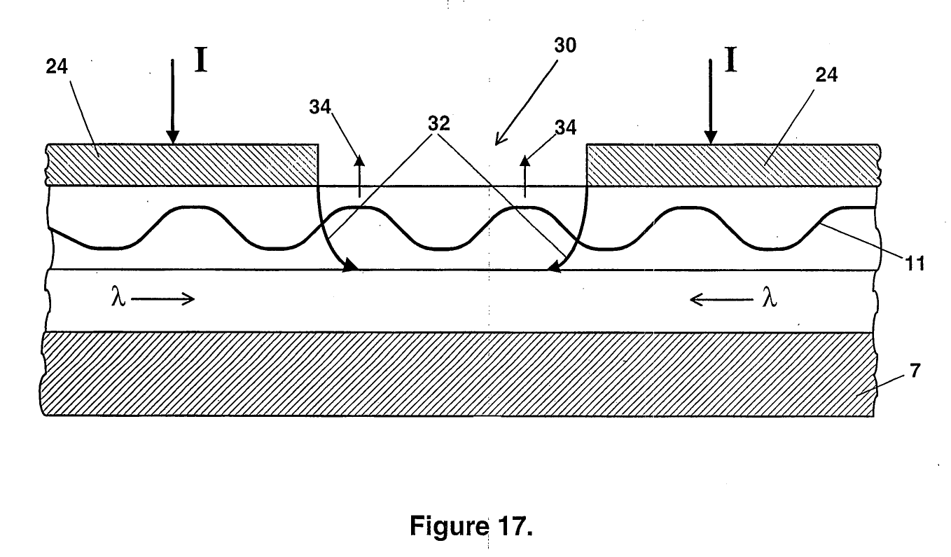

FIG. 17 is a cross sectional view to illustrate the pitfalls of too large an output window;

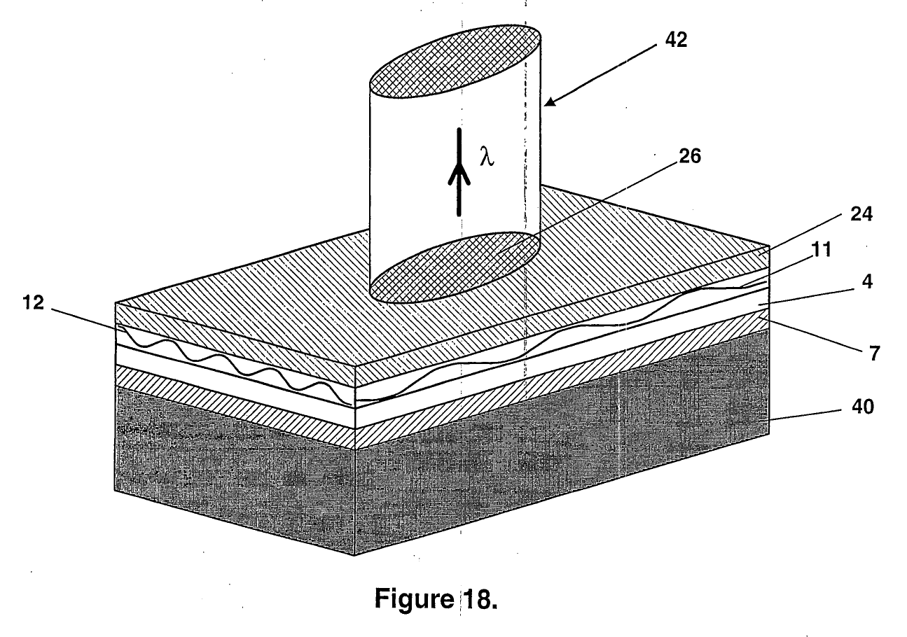

FIG. 18 shows schematically a surface-emitting laser embodying the invention;

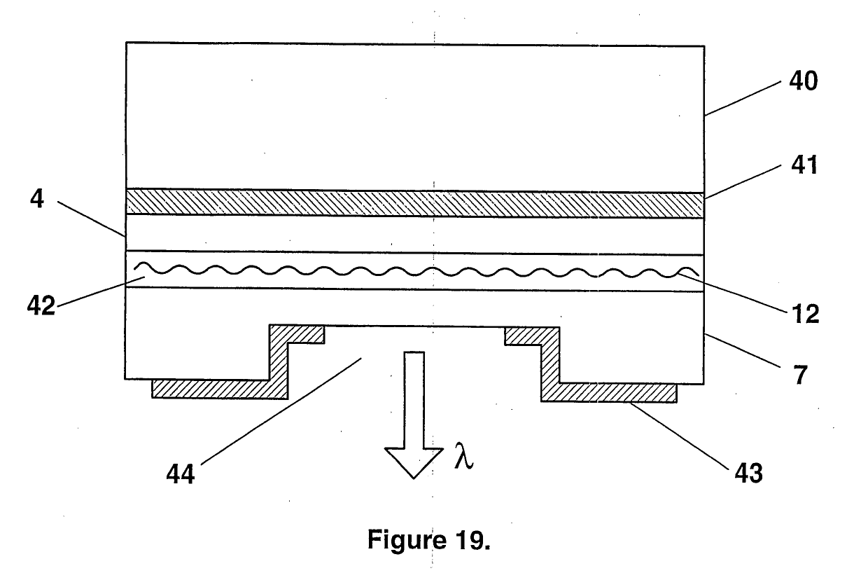

FIG. 19 shows a further embodiment of laser with emission from an opposite surface; and

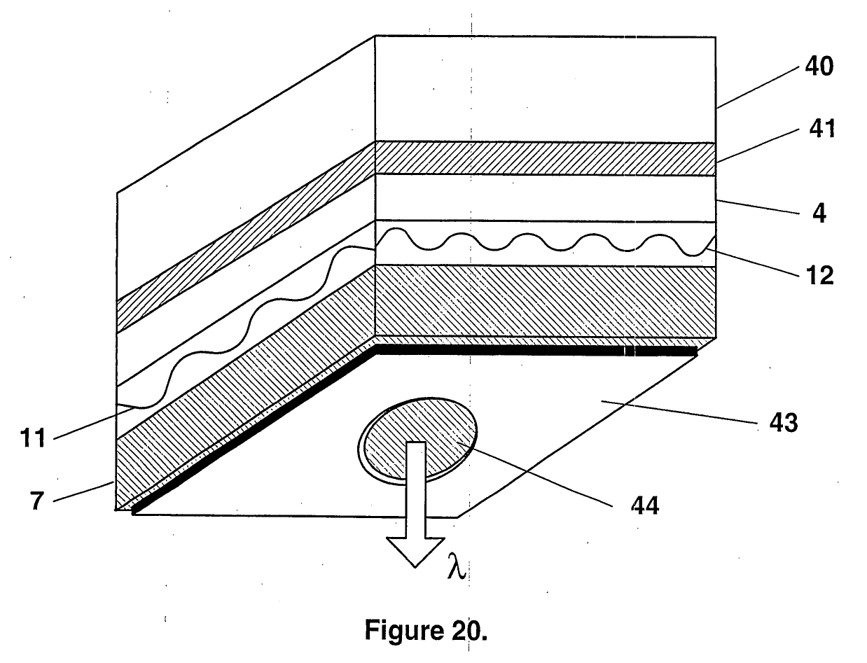

FIG. 20 is a perspective schematic view of the laser of FIG. 19.

Referring now to FIG. 3, there is shown in plan view, and in sectional views taken along the lines B-B and C-C, part of a DFB laser operating at free air wavelength λ. The laser 8 is constructed in the form discussed with respect to FIGS. 1 and 2 with common item numbers representing common functionality. Area 6 is a metal electrode by which the laser is electrically pumped, area 9 is a window which is transparent to electromagnetic radiation of wavelength λ above the Bragg gratings and is the port though which the out-coupled electro-magnetic radiation 5 would be emitted.

The pitch of gratings for photonic applications are sub-micron, for example 200-300 nm, and are therefore not readily amenable to being defined using standard photolithography techniques. Two commonly used technologies for the production of gratings of the pitch required are direct electron beam writing and holographic interference. Both techniques can be used to write a grating directly onto a photoresist coating covering the wafer.

Our co-pending British patent application number 0115059.8, “Method of creating Bragg Gratings in Optical Waveguide Devices”, describes a holographic process by which lattice gratings can be written onto semiconductor wafers. A photoresist-coated wafer is exposed sequentially to two interfering beams of electro-magnetic radiation. The first and second exposures are angularly offset by rotating the target about a substantially orthogonal axis to create two intersecting Bragg gratings with a native pitch Λ₀. FIG. 4 shows schematically such an example. The wafer 10 is exposed as detailed above and the two gratings 31 and 32 are offset by an angle φ. Where the two Bragg gratings overlap, the negative photoresist experiences an increased exposure and so will have an increased hardness. These regions of increased hardness 33 define alternative lattice gratings. FIG. 4 shows two such gratings with pitch Λₕ and Λᵥ.

FIG. 5 shows schematically the first order laser gratings 110 and 120 that result from the writing of two native pitch gratings 130 at an angle φ to each other, as in the above method. The pitch Λ₁ of grating 120 is akin to Λ_{M(1-10)} and the pitch Λ₂ of grating 110 is akin to Λ_{M(1-10)}. For a constant native pitch the variable that determines the respective pitches Λ₁ and Λ₂ is φ—the angle of rotation of the target wafer between the first and second exposures. By suitable choice of φ, Λ₁ can be made equal to Λ/2n_{eff} and Λ₂ can be made equal to Λ/n_{eff}. FIG. 5 also includes waveforms 140 and 150 showing modulation in the refractive index of the completed grating structure.

The wavelength of operation of a DFB laser is given by:

$$λ = \frac{2 {n}_{eff} \times Λ}{m} \qquad ( 1 )$$

where λ is the wavelength of the emitted electromagnetic radiation, n_{eff} is the effective refractive index seen by the propagating wavefront in the active layer, Λ is the pitch of the Bragg grating and m is the order of the laser grating, i.e. relative number of wavelength distances within the material, given that in one direction, m is usually unity. Thus for a pump laser operating at 1480 nm, using a Group III-V active waveguide with a typical n_{eff} of 3.2, the basic grating pitch needs to be 230 nm

A surface-emitting laser of the type described for operation at 1480 nm would therefore require grating pitches of Λ₁=230 nm (m=1) and Λ₂=460 nm (m=2).

By way of example a holographic system using an Argon Ion Ultraviolet laser with a wavelength of 351.1 nm, may be used to produce a grating of native pitch Λ₀, of 411 nm. The pitches of the lattice gratings are given by:

$$\begin{matrix}{Λ}_{M ( 1 - 10 )} = \frac{{Λ}_{0}}{2 \times Sin ( \frac{φ}{2} )} & ( 2 ) \\ {Λ}_{M ( 110 )} = \frac{{Λ}_{0}}{2 \times Cos ( \frac{φ}{2} )} & ( 3 )\end{matrix}$$

Substituting these numbers into equation (2) or (3) establishes that for the production of first order lattice gratings with pitches of 230 nm and 460 nm the angle φis nominally 530°.

Thus in this worked example, using the techniques of the holographic grating process of our co-pending patent application, first order lattice gratings can be produced that have the correct orders of pitch for generating 1480 nm laser light by surface emission.

The gratings have been portrayed diagrammatically as simple lines. In reality the native gratings are sinusoidal, producing graded density of hardness across the pitch. Thus where the native lattice gratings intersect there is a further graded hardening of the photoresist. By choice of photoresist, angle of holographic interference, and exposure time, the profile of the Bragg gratings can be manipulated to produce a variety of cross section profiles as shown in FIG. 6(a-d). Thus by means of varying the exposure times and or development time of the photosensitive recording medium the planar pattern of the intersecting grating structure may be determined. Depending upon whether positive or negative photoresist has been used, the planar pattern developed may have the form of peaks or wells. Equally variation in exposure and development time can produce peaks or wells in the fabricated grating, as will be appreciated by those of ordinary skill in the art.

It should be appreciated that it is also possible to produce the Bragg gratings by means of electron beam writing. One of the disadvantages of writing the Bragg gratings using the holographic method is that the first and second order gratings are the same strength. In some design instances it is envisaged that it will be desirable to increase the strength of the second order grating compared to the first order grating to enhance the out-coupling of light. By using direct electron beam writing it is possible to change the profile of the Bragg gratings to enhance either the first or second order gratings. FIG. 7 shows an example where the lattice has nodes 70 that are rectangular in shape. Considering the repeat unit 73 of the lattice, light propagating in the direction of the first order grating sees a strong grating as shown by the large change in refractive index 71. Light propagating in the direction of the second order grating sees a much weaker grating as shown by the change in refractive index 72. FIG. 8 shows the case where the nodes 74, which have the same area as in FIG. 7, have a different profile and the strength of first order lattice is reduced while the strength of the second order lattice is increased.

In the structure of the DFB laser shown schematically in FIG. 1 the active region is defined as a stripe 210. In order to obtain maximum power output the first order Bragg grating is aligned with the direction of the stripe. However to obtain surface emission the two lattice gratings have to be orthogonal. Thus in the geometry shown in FIG. 1 light propagating along the active region of the laser will interact strongly with the first order grating while there will be minimal interaction with any second order grating due to the device geometry, hence there will be an insignificant out-coupling of light.

To obtain efficient surface emission, modifications to the geometry of the laser need to be made to allow the generated light to explore the whole of the active region of the laser and thus see the first and second order gratings. This will allow out-coupling to occur and thus the surface emission of light, although care must be taken to ensure that too much light is not out-coupled and the laser quenched.

In a first embodiment, the shape of the laser is irrational i.e. it does not have harmonically related dimensions. Such a shape is shown in FIG. 9, where an irrational rectangle 20 has unit short dimension and a long dimension given by the value (√5+1)/2 i.e. 1.618034. Shape 20 is used for all layers of the laser of this embodiment.

This embodiment will now be described by reference to the various DFB laser layers, each of which has the irrational shape 20 of FIG. 9.

FIG. 10 shows the grating layer in which the grating comprises Bragg lattice gratings 11 and 12 created using either electron beam writing or the above holographic process, and in which the first order grating 11 has half the pitch of the orthogonal second order grating 12. The gratings 11 and 12 are deliberately created to be not parallel with either the short or long dimension and are preferably at 45° to each in order to allow the emitted light to cover the whole of the surface area of the device.

FIG. 11 shows the grating layer 290 located atop the active layer 210 which, when electrically pumped, undergoes stimulated luminescence. The electro-magnetic radiation that is emitted interacts with the first order Bragg grating 220 and undergoes reflection and constructive interference. The active layer also acts as a waveguide since it is bounded by materials of lower refractive index. The edges of the laser 16, 17, 18, 19 as shown in FIG. 12 are cleaved and/or dry etched and so, on reaching these edges, the electro-magnetic radiation undergoes total internal reflection. The electro-magnetic radiation is also simultaneously interacting with the second order Bragg grating and out-coupling will take place where the device geometry allows.

A typical path 22 is shown in FIG. 12. It can be seen that as a result of the laser device shape being irrational any given path will traverse the whole of the device with equal interaction with both the first and second Bragg gratings. FIG. 1, shows the electrode layer 90 of the device that is located atop the Bragg grating layer. The electrode layer comprises a metal Lo inject carriers to pump the active layer of the device, but will also act as a barrier to the emission of electro-magnetic radiation that attempts to couple out when interacting with the second Bragg grating. In the electrode layer there is a window 91 not of metal, which comprises a portal through which electromagnetic radiation can emerge. The window 91 is shown as a square but it should be appreciated that there are a variety of shapes that can be used depending on the output requirements (see FIG. 16).

A second embodiment is where the shape of the laser is rational with sides in the ratio 2:1 The grating layer in this embodiment is the same as that in the first embodiment and as shown in FIG. 10, it comprises Bragg lattice gratings 11 and 12 created using either electron beam writing or the holographic process, and in which the first order grating 11 has half the pitch of the orthogonal second order grating 12. The gratings 11 and 12 are deliberately created to be not parallel with either the short or long dimension and are preferably at 45° to each side to allow the emitted light to cover the whole of the surface area of the device.

The laser is constructed in the same general form as the first embodiment and common item numbers represent common functionality. The edges 16, 17, 18, 19 of the laser shown in FIG. 14 are cleaved and/or dry etched and so on reaching the edges the electro-magnetic radiation undergoes total internal reflection.

FIG. 14 also shows the electrode layer 90 of the device that is located atop the Bragg grating layer. The electrode layer comprises a metal that allows the injection of carriers to pump the active layer of the device, but will also act as a barrier to the emission of electro-magnetic radiation that attempts to couple out when interacting with the second order Bragg grating. In the electrode layer there is a window 91 that is not metal but a portal through which any electromagnetic radiation can emerge. The window 91 is shown as a square but it should be appreciated that any of a variety of shapes can be used depending on the output requirements. In this case, window 91 is arranged in such a manner that the sides of the window are parallel and orthogonal to the first and second order lattices. Light following the path indicated by sections 61 to 68 firstly travels in the direction of the first order lattice (sections 61, 62), then in the direction of the second order lattice (sections 63, 64, 65, 66) and then in the direction of the first order lattice (sections 67, 68). FIG. 15 shows that light travelling in this structure will out couple light for nominally one eighth of the total path length travelled. This Light will interact with the first and second order gratings in equal measure.

The square opening will produce a beam of laser light suitable for coupling into further optical devices via traditional, optics and lenses. It should be noted that the emergent beam, although divergent, would not be as highly divergent as the laser light emitted from the traditional stripe laser structure as shown in FIG. 1.

In both the embodiments discussed there is a number of different electrode geometries that can be used. With reference to FIG. 16(a), (b) and (c) there are shown a range of alternative electrode layers 24 with differently shaped windows 27, 28, 29. In FIG. 16(a) window 27 is rectangular or square and it can be arranged that the sides of the window are parallel to the Bragg gratings, or are aligned at some arbitrary angle.

In FIG. 16(b) window 28 is circular, elliptical, or oval which allows the emitted electro-magnetic radiation to match the single mode propagation profiles of fibres and waveguides. The major axis of the widow can be arranged so that it is parallel to the Bragg gratings, or aligned thereto at some arbitrary angle.

The size of the windows 27 and 28 can be adjusted to vary the maximum potential power output, but there are restrictions on the size of the windows. If the second order grating is strong and the light is out-coupled strongly then too much light may be out-coupled and the laser will be quenched.

A further problem also occurs if the window is too large. FIG. 17 shows part of the device with a window 30 in the electrode layer 24. Electro-magnetic radiation 34 is output due to diffraction within the second order Bragg grating 11. Carrier injection occurs via the electrode material 24. If window 30 is too large, a region of lower light emission will occur in the centre of the window. This is due to a reduction in the inversion population in the material and so more absorption rather than emission of photons occurs. This puts a limit on the size of a single window.

Window 29 shown in FIG. 16(c) overcomes this problem by having a plurality of small windows, the totality of which will have a higher power output than a single window of the same overall area. By adjusting the dimensions of the windows and their spacing the “pepper pot” design can be adjusted to give the required intensity profile in the emitted laser beam.

FIG. 18 shows schematically a laser embodying the invention wherein a heat sink 40 acts as return path for the electrical pump energy, 7 is the laser substrate, 4 is the active layer, 11 is the second order Bragg grating, 12 is the first order Bragg grating, 24 is the electrode layer and 26 is the window though which the output laser energy 42 is radiated.

In a further embodiment where laser emission occurs from the opposite side of the device compared to the previous two embodiments, with reference to FIGS. 19 and 20, where common numbers represent the same as previously, a heat sink 40 is attached to a continuous metal electrode 41 that covers the whole of the laser. The active layer 4 is adjacent the layer 42 containing the Bragg gratings, including the second order Bragg grating 11, and the first order Bragg grating 12. An InP substrate 7 is substantially transparent to the wavelength λ emitted by the laser, and electrode 43 has a window 44 in it. The size of the window 44 can be adjusted to vary the maximum potential power output. It will be appreciated that as in the previous two embodiments a variety of electrode structures can be used and that there are limitations on the size of the window 44. Light generated in the active region interacts with the Bragg gratings 11, 12 and is out-coupled through the p-doped InP in-fill layer and the InP substrate. The InP substrate is substantially transparent to the emitted light and to reduce absorption is etched to reduce the thickness of material through which the emitted light has to pass through.

The surface-emitting laser has the advantages that it will have high-emitted power, it will have a large surface area, it will have controllable out-coupling, and it will have a simpler structure compared to other surface emitting lasers.

1. A surface emitting lasers comprising an active layer bounded on one face by a Bragg grating layer having a first lattice grating of pitch equal to λ/2n_{eff} and a second lattice gating orthogonal thereto and having a pitch greater than λ/2n_{eff} , where λ is the wavelength of the emitted electromagnetic radiation, and n_{eff} is the effective refractive index experienced by the propagating wavefront in the active layers.

2. The surface emitting laser as claimed in claim 1, wherein the pitch of the second lattice grating is a multiple of that of the first lattice gating.

3. The surface emitting laser as claimed in claim 2, wherein the pitch of the second lattice grating is twice that of the first lattice gating.

4. The surface emitting laser as claimed in claim 1, wherein the Bragg grating layer is formed by a holographic process in which a photoresist layer is first exposed to first and second coherent electromagnetic beams and is then exposed to the first and second coherent electromagnetic beams at a predetermined angular offset from the first exposure.

5. The surface emitting laser as claimed in claim 1, wherein the Bragg grating layer is formed by direct electron beam writing.

6. The surface emitting laser as claimed in claim 1, wherein the second lattice grating is stronger than the first lattice gating.

7. The surface emitting laser as claimed in claim 1, wherein the second lattice grating is equal in strength to the first lattice grating.

8. The surface emitting laser as claimed in claim 1, wherein the Bragg grating layer is configured as an irrational rectangle.

9. The surface emitting laser as claimed in claim 8, wherein the rectangle has dimensions in the ratio of 1:(√5+1)/2.

10. The surface emitting laser as claimed in claim 1, wherein the Bragg grating layer is configured as a rectangle having one dimension a rational multiple of another dimension.

11. The surface emitting laser as claimed in claim 1, further comprising an electrode layer disposed adjacent to the Bragg grating layer, said electrode layer having window means to permit exit of laser light.

12. The surface emitting laser as claimed in claim 11, wherein said window means has a quadrilateral shape.

13. The surface emitting laser as claimed in claim 12, wherein the window means is square.

14. A surface emitting laser as claimed in claim 12, wherein a side of the window means is aligned parallel with one of the first and second lattice gratings.

15. The surface emitting laser as claimed in claim 12 wherein a side of the window means is aligned at a predetermined angle to one of the first and second lattice gratings.

16. The surface emitting laser as claimed in claim 11, wherein said window means is one of circular, elliptical and oval.

17. The surface emitting laser as claimed in claim 11, wherein said window means comprises a plurality of small apertures distributed over a window zone of the electrode layer.

18. The surface emitting laser as claimed in claim 1, further comprising an electrode layer including window means spaced from said Bragg grating layer by a transparent laser substrate layer.

19. (canceled)
